(19) United States
(12) Patent Application Publication
(10) Pub. No.: US 2014/0059242 A1
(43) Pub. Date: Feb. 27, 2014

(54) METHOD AND SYSTEM OF IMPLEMENTING DATA LOAD PROTOCOLS

(71) Applicant: GE AVIATION SYSTEMS LIMITED, Gloucestershire (GB)

(72) Inventors: Timothy John Wood, Stroud (GB); Randal Kevin Walker, Cheltenham Spa (GB)

(73) Assignee: GE AVIATION SYSTEMS LIMITED, Gloucestershire (GB)

(21) Appl. No.: 13/652,723

(22) Filed: Oct. 16, 2012

(30) Foreign Application Priority Data
Aug. 22, 2012 (GB) 1214921.7

(51) Int. Cl. G06F 15/16

(52) U.S. Cl. 709/230

(57) ABSTRACT

A system and method uses a proxy device to enable use of a standard data load protocol to load data to a target device that is incompatible with the standard data load protocol.

### BACKGROUND OF THE INVENTION

Software data load protocols are used for loading software to compatible line replaceable units in aircraft. Data load protocols for avionic applications are typically designed to support the widest possible range of target devices. System integrators often want to extend the use of a given protocol to as many components in an aircraft system as possible in order to simplify the maintenance aspects associated with the system. Consequently, data load protocols achieve a level of complexity that is not always cost effective to implement in simpler or smaller devices, or older devices that are incompatible with newer data load protocols.

Attempts to resolve the problem of adapting data load protocols to simple or legacy devices that cannot accept the complexities of most single solution data load protocols include (1) modifying the target equipment to include needed additional functionality, and (2) providing a gateway whereby the communication medium is adapted to a simpler or lower cost medium but with the data load protocol still being handled by the target device. The first results in increased cost and development time, and may involve the provision of different or additional communication media as well as the provision of additional functionality to support the required protocol. Either provision may require costly changes to hardware design in order to support requisite interface and processing changes. The second may address the problem of cost associated with the physical connectivity but does not alleviate the need to implement the data load protocol functionality in the simple or legacy devices.

### BRIEF DESCRIPTION OF THE INVENTION

One aspect of the invention includes a system for loading data into a target device with a standard data load communication protocol where the target device is incompatible with the standard data load communication protocol. The system includes a media repository for storing data; a data loader configured to communicate data using a standard data load communication protocol; a target device configured to communicate using a proprietary data load protocol native to the target device that is incompatible with the standard data load communication protocol; and a proxy device intermediate the data loader and the target device wherein the proxy device is configured to translate communications between the standard data load communication protocol and the proprietary data load protocol.

Another aspect of the invention includes a method of loading data into a target device using a standard data load communication protocol where the target device is incompatible with the standard data load communication protocol. The method includes the steps of retrieving data from a media repository; downloading the data to an intermediate proxy device using a standard data load communication protocol; configuring the data for transmission using a proprietary data load protocol native of a target device that is incompatible with the standard data load communication protocol; and transmitting the data to the target device using the proprietary data load protocol.

### BRIEF DESCRIPTION OF THE DRAWINGS

In the drawings:

FIG. 1 is a schematic diagram depicting the prior art approach for implementing a data load protocol.

FIG. 2 is a schematic diagram depicting a method of implementing a data load protocol according to the invention.

FIG. 3 is a schematic diagram depicting further detail of the proxy agent in FIG. 2.

### DETAILED DESCRIPTION

In the following description, for the purposes of explanation, numerous specific details are set forth in order to provide a thorough understanding of the technology described herein. It will be evident to one skilled in the art, however, that the exemplary embodiments may be practiced without these specific details. In other instances, structures and device are shown in diagram form in order to facilitate description of the exemplary embodiments.

The exemplary embodiments are described below with reference to the drawings. These drawings illustrate certain details of specific embodiments that implement the module, method, and computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein include a computer program product comprising machine-readable media for carrying or having machine-executable instructions or data structures stored thereon. Such machine-readable media can be any available media, which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general purpose computer, special purpose computer, or special purpose processing machines to perform a certain function or group of functions.

Embodiments will be described in the general context of method steps that may be implemented in one embodiment by a program product including machine-executable instructions, such as program code, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program code for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configuration, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

An exemplary system for implementing the overall or portions of the exemplary embodiments might include a general purpose computing device in the form of a computer, including a processing unit, a system memory, and a system bus, that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Technical effects of the method disclosed in the embodiments include removing a dependency upon the data load protocol so it becomes possible to make use of equipment in a system without the need to add sophisticated management functionality. Significant cost savings can be achieved with a separate proxy function to support data loading and/or other management functions.

This invention provides an alternate means to support software data load protocols in an electronic system when equipment is not capable of supporting the required protocol or it is preferable not to incorporate such support, for example where legacy equipment is being used. The invention allows a designated system to support the required data load protocol by hosting the data load protocol handling functionality on an alternate module that acts as a proxy device, translating the required protocol and implementing the required behavior in a manner better suited to the intended target. The invention assumes that one or more communication media exist between the data load function and the proxy device and that the same or different communication media exists between the proxy device and the intended target. The invention is primarily developed for avionic systems using an ARINC 615 based data load protocol but is equally applicable to other environments where a particular data load, or other, protocol is required to support system needs but where the provided equipment does not natively provide support for the required protocol. The new and novel aspect of the invention is the application of a proxy function to software data load applications. This approach allows the implemented system to use a common data load protocol with equipment that does not natively support the chosen common data load protocol.

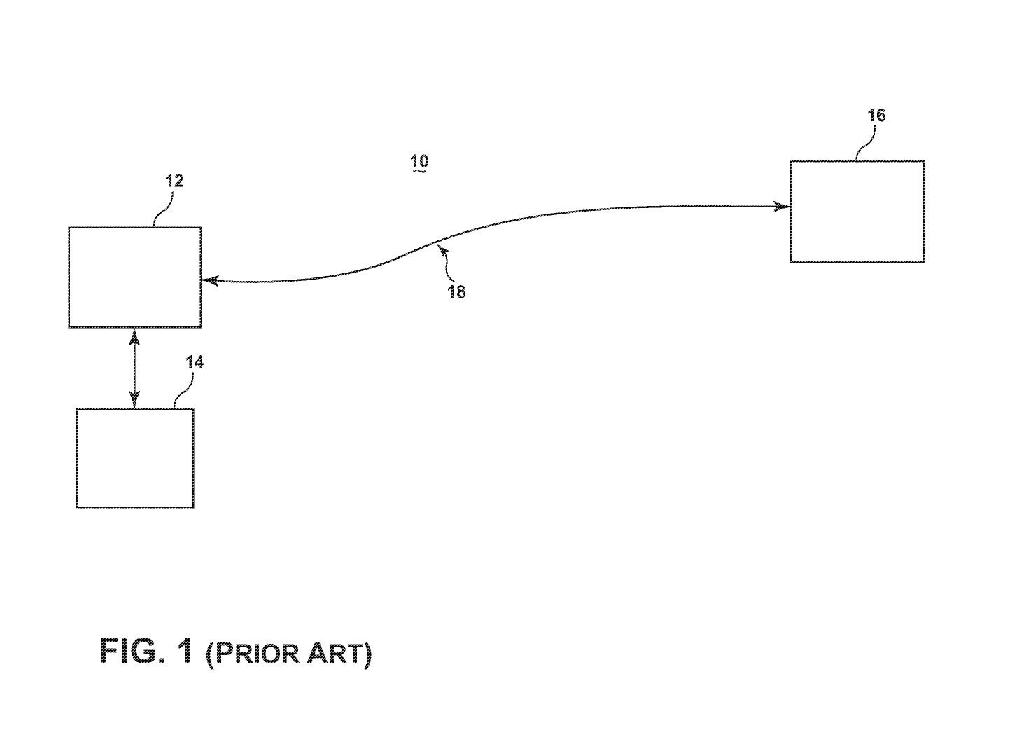

Referring now to FIG. 1, a traditional approach 10 would entail a data loader 12 having a data load function that accesses a media repository 14 and communicates directly with a target device 16 to implement data load functionality (i.e., transmits data to the target device 16) using a standard data load communication protocol 18. This approach simplifies maintenance aspects of a system, but it requires the target device 16 to implement the standard data load communication protocol 18. A problem that the traditional approach 10 approach presents is that the target device may be incapable of implementing the standard data load communication protocol 18. For example the target device may and lack the processing capacity to handle the standard data load communication protocol 18, or it may be too old to accommodate a newer standard data load communication protocol 18, and use a proprietary data load protocol. In some cases a potential target device may require upgrading or replacement. In other cases, the potential target device may be ignored altogether in the maintenance system. In other cases, the standard data load communication protocol 18 may be recoded to match the requirements of the target device. All such potential solutions are costly, time consuming, and labor-intensive.

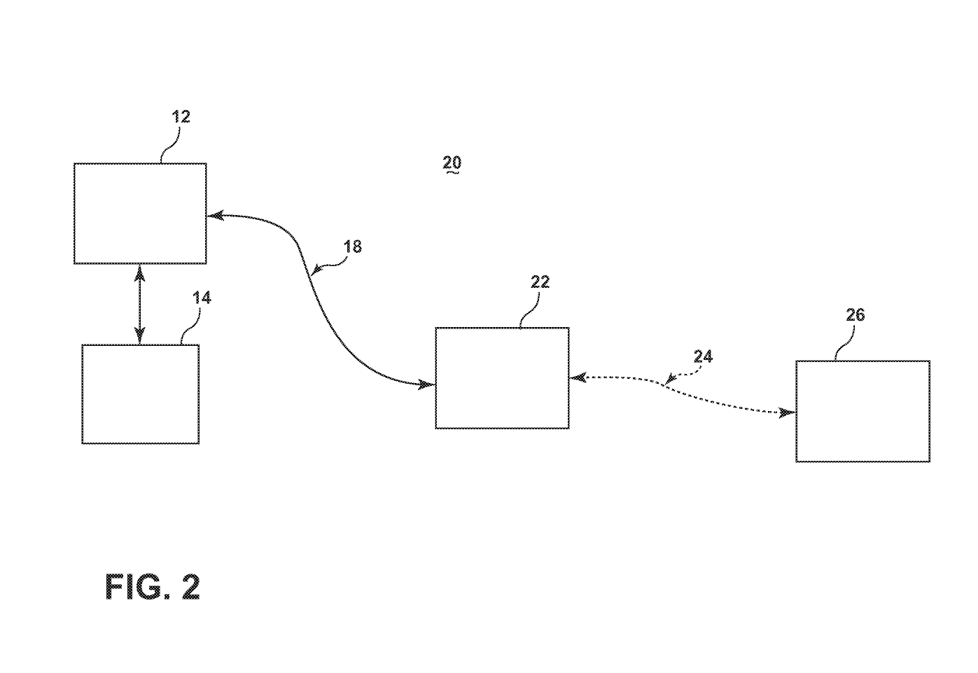

Referring now to FIG. 2, an alternative approach 20 according to the invention includes a data loader 12 accessing a media repository 14 as in the traditional approach of FIG. 1. Here, however, at least one intermediate proxy device 22 provides a translation function between the standard data load communication protocol 18 and a proprietary data load protocol 24 implemented in a target device 26 that is otherwise incapable of directly accommodating the standard data load communication protocol 18. The standard data load communication protocol 18 may be standardized or it may be a system-specific data load communication protocol by which the intermediate proxy device 22 supports communication with a standard data load function. But the intermediate proxy device 22 may provide multiple functions, such as also translating the standard data load communication protocol 18 into a form that is more appropriate to the intended target device, e.g., the proprietary data load protocol 24, and validity checking to ensure the integrity of authorship, payloads, and sources. For example, the proxy device 22 can check that the payload is correct, e.g., without transmission error or loss via checksums and related means. As well the proxy device 22 can also check authorship, e.g. that a payload is not being ‘spoofed’ via digital signatures. Such multiple functions can be conducted individually or concurrently.

A benefit of this approach is that the intermediate proxy device 22 may provide data formatting translation, for instance to pack or unpack data. As well, it is contemplated that the intermediate proxy device 22 will also be configured to handle both up-load and down-load of data items. In other words, the intermediate proxy device 22 can be considered to be bi-directional or to be two proxies in one. Indeed, the data load function and the target of the data load each behave as both client and server during the data load process. Moreover, the intermediate proxy device 22 provides complete file transfer support services such as reporting unit identity and unit status (i.e. what has been loaded), directly interacting with the data stream to buffer and to segment or reassemble the data stream, and full control of the transfer process. Application of this approach is contemplated particularly for data loading in the avionics of an aircraft where the standard data load communication protocol is defined by an ARINC 615A data loader, and with media formats governed by ARINC 665 and transfer/transport integrity requirements governed by ARINC 666.

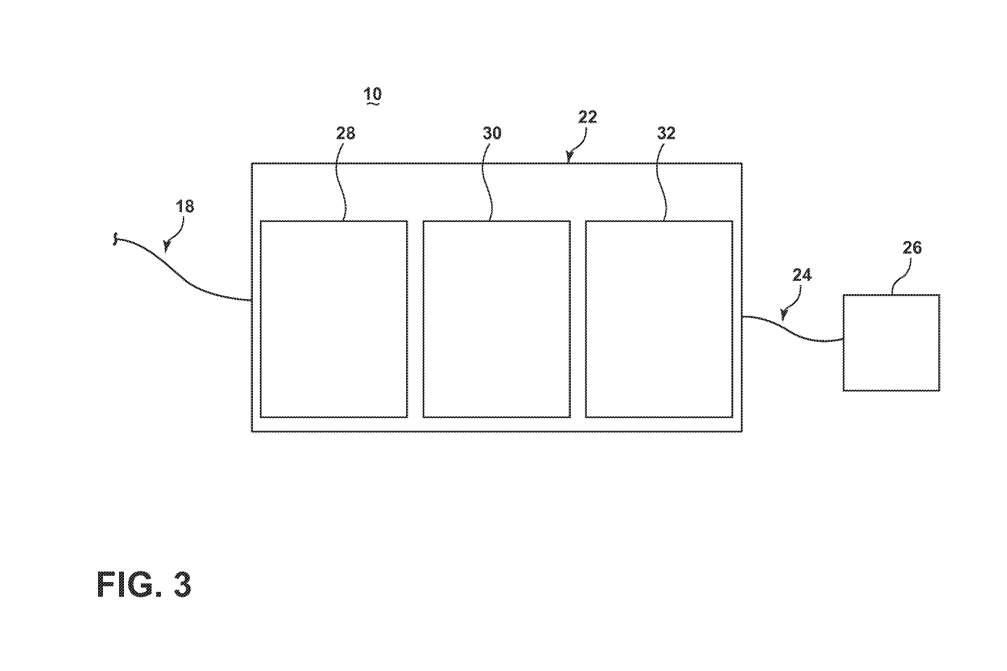

Referring now to FIG. 3, the intermediate proxy device 22 has three main components. One component is a data load protocol agent 28 that interacts with the data load function using the standard data load communication protocol 18 chosen to support the system. This allows the data load function, and therefore the system, to treat non-native target devices in the same way as other, native, target devices. Another component is a data manager 30 that provides intermediate data storage and formatting to map between system data load formatting such as data formats in the media repository 14, and data formats required by the target device(s) 26. The data manager 30 could take the form of a store-and-forward mechanism to allow data validation to be performed by the proxy function before forwarding to the target device 26, but could provide pass-through data transfer in order to provide faster response. Another component is a target protocol agent 32 that interacts with one or more target devices 26 to transfer data from intermediate storage 28 into the target device(s) 26. If the intermediate proxy device 22 interacts with multiple target devices, the target protocol agent 32 could additionally support multiple different target protocols and/or handle target load synchronization.

The intermediate proxy device 22 may be implemented on dedicated hardware, as a supplementary function on existing hardware, or as a software application on a common processing resource depending upon the type of system being designed, the resources available in that system, and a cost analysis for the system. The target device(s) 26 may be any manner of device chosen to be a part of the system but which do not implement the chosen standard data load communication protocol 18. Exemplary target devices 26 for use with this invention include commercial off-the-shelf (COTS) devices, simple programmable sensors, small data-concentrator devices, switches, and simple remote electronic units.

By removing a dependency upon a standard data load communication protocol 18, it is possible to utilize equipment in a system without the need to add sophisticated management functionality. This approach saves cost in the supplied equipment while maintaining system functionality by providing a separate proxy function to support the target data load functions or other management functions. For example, if a legacy target device or a simple target device were to be added to the system, the functionality required to support the standard data load function or other management functions would have to be added to the new device or to the system, which would significantly increase the cost associated with the device and delay the point at which it could be introduced to an environment that requires support for the standard protocol. Implementing a separate proxy function to handle the management functions such as data load may provide a lower cost solution or provide other benefits such as shorter development times.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for loading data into a target device using a standard data load communication protocol where the target device is incompatible with the standard data load communication protocol comprising:
a media repository for storing data;
a data loader configured to transmit data using a standard data load communication protocol;
a target device configured to communicate using a proprietary data load protocol native to the target device that is incompatible with the standard data load communication protocol; and
a proxy device intermediate the data loader and the target device wherein the proxy device is configured to receive, validate and translate the standard data load communication protocol into the proprietary data load protocol.

2. The system of claim 1 wherein the intermediate proxy device comprises a data load protocol agent that interacts with the standard data load communication protocol.

3. The system of claim 1 wherein the intermediate proxy device comprises a data manager that provides one of intermediate data storage and formatting to map between data load formatting and data formats required by the target device.

4. The system of claim 1 wherein the intermediate proxy device comprises a target protocol agent that interacts with the target devices to transfer data using the proprietary data load protocol.

5. A method of loading data into a target device using a standard data load communication protocol where the target device is incompatible with the standard data load communication protocol, the method comprising:
retrieving data from a media repository;
downloading the data to an intermediate proxy device using a standard data load communication protocol;
configuring the data for transmission using a proprietary data load protocol native of a target device that is incompatible with the standard data load communication protocol; and
transmitting the data to the target device using the proprietary data load protocol.

6. The method of claim 5 wherein configuring the data for transmission comprises translating the standard data load communication protocol into the proprietary data load protocol.

7. The method of claim 5 wherein configuring the data for transmission comprises storing the data in a data manger.

8. The method of claim 5 wherein configuring the data for transmission comprises formatting to map between data load formatting of the media repository and data formats required by the target device.
